(19) United States
(12) Patent Application Publication
(10) Pub. No.: US 2022/0319263 A1
(43) Pub. Date: Oct. 6, 2022

(54) Electronic Seal and Location Lock

(71) Applicant: Darvin Scott, Napa, CA (US)

(72) Inventor: Darvin Scott, Napa, CA (US)

(21) Appl. No.: 17/682,088

(22) Filed: Feb. 28, 2022

Related U.S. Application Data
(60) Provisional application No. 63/168,358, filed on Mar. 31, 2021.

(51) Int. Cl. G07C 9/00

(52) U.S. Cl. CPC G07C 9/00944; G07C 9/00714; E05B 67/22

(57) ABSTRACT

The present invention is an improved electronic lock for use on cargo containers, storage trailers, tractor-trailers, houses, sheds, vehicles or other structures. The improved electronic lock communicates with a mobile wireless communication device such as a smart phone, and may be selectively locked or unlocked. The improved electronic lock may be configured as two independent locking mechanisms within one locking unit and having a traditional shackle-style locking portion and another locking shank portion for securing (or sealing) door latch bars commonly found on tractor-trailer cargo doors. The improved electronic lock further includes a Global Positioning System (GPS) so that the secured (or sealed) cargo container or trailer can be tracked by the improved lock device's location.

### CROSS-REFERENCE TO RELATED APPLICATION

The present application claims priority to, and the benefit of, U.S. Provisional Application No. 63/168,358, which was filed on Mar. 31, 2021, and is incorporated herein by reference in its entirety.

### FIELD OF THE INVENTION

The present invention relates generally to the field of electronic locks. More specifically, the present invention relates to an improved electronic lock that may be installed on a cargo container, storage trailer, tractor-trailer, house, shed or other structures or vehicles for the purpose of securing or sealing the doors on the cargo container, structure, vehicle or trailer. The improved electronic lock communicates with a mobile wireless communication device, such as a smart phone, and is locked and unlocked using a novel software application that is downloaded and installed on the smart phone. The improved electronic lock may include a detachable rechargeable battery that may be recharged using a separate battery charger. The detachable battery may be disconnected from the improved lock body while still securing the contents of the container, structure, vehicle or trailer. The improved electronic lock has two independent locking mechanisms within one locking unit. The locking mechanism uses a traditional shackle-style locking portion, similar to a conventional padlock. Another locking shank portion secures (or seals) door latch bars commonly found on tractor-trailers, cargo containers and other doors. The improved electronic lock further includes a Global Positioning System (GPS) embedded within the lock so that the secured (or sealed) container, structure or trailer can be tracked by the improved lock device's location. The lock may include other levels of security such as an RFID tag for verification of the lock and recording of times and dates when the lock was opened. Accordingly, the present disclosure makes specific reference thereto. Nonetheless, it is to be appreciated that aspects of the present invention are also equally applicable to other like applications, devices and methods of manufacture.

### BACKGROUND

By way of background, traditional combination or keyed locks are commonly used on various cargo, storage, or tool containers or trailers, vehicles and other structures for securing the contents within the container, structure, vehicle or trailer. Traditional padlocks include a shackle portion at the top of the lock that can be selectively locked or unlocked using the specific combination or key. Traditional padlocks are designed to have the shackle portion of the lock go through an opening in the latch (or hasp) that is attached to the door or lid of the container, structure or vehicle. Further, plastic or wire ties or other similar products are commonly used for securing or sealing the doors of a cargo container or other structure that are typically located on the rear of a trailer. The purpose of the plastic or metal wire tie is to indicate that the doors were open by the truck driver or others while the tractor-trailer is in transit, as typically the tie is frangible and is not easily repairable. The plastic or wire tie serves as a seal that is placed around the door latch bars prior to departure and is then cut-off by an authorized individual once the trailer reaches its destination. The plastic or wire tie is designed to be used one-time, and therefore includes a tamper-proof mechanism that prevents it from being removed without cutting or breaking it to show tampering. It further includes unique identifiers, such as a serial number, code or signature, which makes it difficult to replace the plastic or wire tie without being detected that the tie has been tampered with.

A common problem for padlock and other style locks arises when the user either forgets the combination or loses the key to the lock. In some applications, the padlock is intended to keep the contents of the container secure while it is in transit. In this case it would be difficult for the user to install the lock without having access to the combination or key. Further, a problem for plastic or wire ties that are commonly used for securing the doors on tractor-trailer or cargo containers is that they can only be used one time. Additionally, while the plastic or wire ties can be made to prevent or show tampering during transit, they can be easily cut-off or broken, thereby requiring other locking mechanisms to be placed onto the cargo doors to prevent theft of the contents inside the trailer or structure.

Therefore, there exists a long felt need in the art for an improved electronic lock that can be easily installed onto various cargo containers, storage units, construction site equipment, vehicles, houses, sheds and other structures. There is also a long felt need in the art for an improved electronic lock that can be easily used for securing cargo and equipment without requiring a key or combination to be entered into the locking mechanism to access the interior of the container or vehicle, instead can be locked and unlocked using a portable wireless device, such as a smart phone. Additionally, there is also a long felt need in the art for an improved, reusable electronic lock that can be used to seal trailer and cargo container doors. Further, there is a long felt need in the art for an improved electronic lock that has GPS technology built into the device so that the secured cargo can be tracked and monitored. There is also a long felt need in the art for an improved electronic lock that includes a built-in light for illuminating the lock and surroundings when it is used in a low-light or nighttime environment. Finally, there is a long felt need in the art for an improved electronic lock that is relatively inexpensive to manufacture, strong and durable and has a rechargeable battery that can be detached from the lock body for charging or alternatively may be charged remotely while the battery remains embedded within the unit while still keeping the cargo secured.

The subject matter disclosed and claimed herein, is an improved electronic lock that is designed to be installed onto a cargo container, storage trailer, tractor-trailer, house, shed, vehicle or other structure for the purpose of securing or sealing the doors or entry point on the cargo container, structure or trailer. The improved electronic lock includes an upper lock body member, a lower lock body member, a lockable shackle, a plurality of lockable shanks, a display, a light for lamination, wireless communication, GPS tracking and a detachable rechargeable battery unit. The improved electronic lock communicates with a mobile wireless communication device, such as a smart phone, and is locked and unlocked using a novel software application that is installed on the smart phone.

Each novel lock device has a unique internal serial number or other code that permits it to communicate via Bluetooth® or other commonly available wireless communication protocols. The software application program is downloaded and installed on the smartphone and may require the user to enter a passcode, other information, biometric or use facial recognition to gain access to the novel lock functions such as locking, unlocking, retrieving lock usage information or activating a built-in light to luminate the lock and its surroundings. The built-in light is typically a high intensity LED light bulb, requiring low current draw on the internal battery unit. The novel lock device includes a digital display for updating the user on the status of the lock, including the locked or unlocked state, the current battery charge level, usage information and other data, such as the communication status between the smartphone and itself. The on-board GPS tracking can allow authorized users to communicate with the present invention lock device to provide a real-time location of the novel lock device and its secured contents. The real-time location data can be tracked via the smart phone software application and/or via a unique software tracking program that would allow any number of the novel locking devices to be tracked simultaneously.

The improved electronic lock can function as two locks within one, since it includes both a locking shackle and a plurality of locking shanks. Each portion of the lock can be either locked or unlocked using the smartphone software application. Further, the two separate locking features can be either independently controlled or be made to operate together. The locking shackle of the present invention lock device, typically located near the top portion of the novel device, is similar to a conventional padlock and can be used for securing cargo by inserting it into an opening that is commonly found on traditional latches and hasps. The locking shanks on the improved electronic lock can be configured such that they can secure door latch bars, or other locking elements, which are commonly used on tractor-trailers, cargo containers and other structures. The plurality of locking shanks on the present invention lock is preferably configured as having three shanks, and the outer two shanks can be inserted through an opening in the two door latch tabs. The center locking shank can be sized as having the same length as the two outer shanks or be made longer so that the two portions of the lock body can be held together. Alternatively, the locking shackle could be used for securing the novel lock device when it is not in use as a trailer door seal by attaching it to the end of a chain, which may be permanently attached to the trailer door.

The improved electronic lock includes a rechargeable battery unit, which is preferably attached to the lower lock body member. Further, the rechargeable battery unit is preferably made to be detachable from the lower lock body for recharging purposes, using a separate battery charger. It should be understood that the battery may also be charged without removal and may be charged by magnetic or electronic coupling with a charging unit. While the battery unit is removed from the lower lock body, both the lockable shackle and the lockable shanks of the present invention lock device remain in a locked condition, thereby keeping the cargo or contents secure. GPS tracking is still possible with the battery unit removed, but other wireless communication between the novel lock device and the smartphone software application is suspended until the battery unit is re-inserted onto the lower lock body or otherwise charged. The lock may include one or more RFID devices operating in at least one of the UHF, HF ranges to track usage, or may be provided with a sensor unit to detect the presence of certain environmental conditions, such as temperature, humidity, gases or other potential contaminants, particularly if the contents are perishable.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

The subject matter disclosed and claimed herein, in one embodiment thereof, comprises an improved electronic lock that is designed to be installed onto a cargo container, storage trailer, tractor-trailer, house, shed, vehicle or other structure for the purpose of securing or sealing the doors on the container, vehicle or trailer. The improved electronic lock includes an upper lock body member, a lower lock body member, and a plurality of lockable shanks that join the upper lock body member and the lower lock body member together when said plurality of lockable shanks are in a locked condition.

The upper lock body member includes a lockable shackle that is preferably located near the top of the upper lock body member. The lockable shackle and the plurality of lockable shanks, typically made from hardened steel, have latching ends that can be selectively held in a closed position by internal locking components, such as a locking pawl or latch. These components are not shown, but are commonly used in traditional mechanical lock mechanisms. In the present invention the electronic lock device, the internal locking mechanism is electronically actuated and controlled by an internal control module. The internal control module and the internal locking mechanism are powered by a rechargeable battery unit. The internal control module communicates with a separate portable wireless device, such as a smart phone via wireless communication, which has a software application that was previously downloaded and installed. The upper lock body member includes an antenna for communication with the portable wireless device. The upper lock body member also includes a digital display screen for communicating to the user various status functions of the novel lock device, in addition to a high intensity LED light for luminating the novel lock device and its surroundings. The invention may also have an audible alarm which can be a continuous tone or regular beeping to indicate that the lock is in a locked condition or a loud alarm if the lock is being tampered with or opened when not authorized. The invention may also include an electronic clock such that the lock cannot be opened until a predefined elapsed time has passed, such as the anticipate transit route of a truck. The electronic display and LED light are also connected to the internal control module. The alarm and internal clock may also be connected to the control module.

The internal control module is connected to all of the electronic subsystems of the improved electronic lock including the display, the LED light, the rechargeable battery, the wireless communication antenna, the locking pawls for the lockable shackle and the lockable shanks, and the GPS tracking identifier. In addition, the module may be connected to the alarm and internal clock where provided. The internal control module is programmed to have a unique serial number or code for each novel lock device so that it can be paired with the smart phone, and may further include a user passcode or number on the smart phone software application for accessing the novel lock status and functions. The user communicates with the novel lock device using a wireless communication protocol such as Bluetooth® using a smart phone. The wireless communication data from the smart phone is sent to and from the wireless communication data on the improved lock device of the present invention through its wireless communication antenna.

The lower lock body or housing member includes openings for at least one if not a plurality of lockable shanks that are preferably located on the planar surface near the top of the lower lock body member. The size and position of the openings correspond to similar size and position of the latching ends of the lockable shanks, which are part of the upper lock body member. The lower lock body member further includes electrical contacts and battery attachment notches for receiving a battery unit. The battery unit of the present invention is also rechargeable using a separate battery charger and the battery may be charged while in the housing or removed from the housing. Electrical contacts and battery attachment clips on the detachable battery unit are sized and positioned to mate with the corresponding electrical contacts and battery attachment notches on the lower lock body member. The same electrical contacts and battery attachment clips on the battery are also used to mate with corresponding electrical contacts and battery attachment notches that are on the charger base of the battery charger. A battery release button on the battery unit facilitates removal of the battery from either the lower lock body member or housing or the battery charger. The power cable on the battery charger is connected to standard household service voltage, and the charging status of the battery can be observed via the charging status lights on the charger base. Alternatively, the battery may be charged by capacitively coupling the battery to a charging unit, thereby eliminating the need to remove the battery from the housing.

The upper lock body member and the lower lock body member are preferably made from steel, stainless or hardened steel, and may include alloys containing Teflon® or other low-friction or self-lubricating materials. The lockable shackle and the lockable shanks are typically made from hardened steel. The internal components of the novel lock such as the locking pawls, actuators, springs, cams, screws and pins are made from similar materials and methods and commonly found on traditional or conventional padlocks. The lockable shanks include a locking pawl notch located near the latching end of each of the shanks for contact with a corresponding sized locking pawl or actuator located internal to the lower lock body member or housing. When the locking pawl or actuators are retracted, the lockable shanks are slidable, thereby allowing the upper lock body member and the lower lock body member to be separated (i.e., unlocked condition). When the lockable shanks are inserted into the openings in the lower lock body member and the pawl or actuators are released, the lockable shanks are fixed in place (i.e., locked condition). In a similar manner, the lockable shackle can be selectively unlocked or locked by controlling its locking pawl or actuator.

In another embodiment of the present invention, an improved electronic lock as previously described can be used as a seal for a trailer, cargo or other storage container or vehicle. A tractor-trailer and improved lock can be described as having a tractor for transporting a trailer and or cargo container and it is desirable to place a wire or plastic tie seal onto the cargo or compartment doors, thereby indicating any tampering of the cargo. As previously described herein, the present invention lock device can serve as a reusable seal for tractor-trailers and other cargo or storage containers having doors or other closures that utilize latch bars that pivotally rotate, thereby allowing the doors to either open or to be secured in a shut or locked position. This particular design of cargo doors can be sealed by either the traditional use once plastic or wire tie along with the improved electronic lock device. Each of the cargo latch bars includes a door latch tab having an opening. When the cargo doors are shut, a plastic or wire tie can be placed through each of the door latch tab openings thereby preventing rotation of the door latch bars without breaking the tie, thus indicating a tampering attempt. The novel lock can replace or be included with the plastic or wire tie by inserting the latching end of the outer two lockable shanks through the opening in each of the door latch tabs, then inserting the lower lock body member onto the plurality of lockable shanks and activating the locking process on the smart phone software application. The tractor-trailer and improved lock are now ready for transit to its destination. The internal clock can be activated to further secure the lock for the anticipated duration of the transit time. The internal alarm can then issue a regular or intermittent tone to indicate the lock is in a locked condition.

The improved electronic lock of the present invention is particularly advantageous because it may be used in conjunction with various types of trailers, vehicles, buildings, vehicle and other storage containers or vehicles. The improved electronic lock comes in various configurations and may be painted any color based on the user's desires and may include logos and other instructional decals without limitation. The improved electronic lock may be sized to accommodate containers ranging from small to very large, depending on the needs of the user.

To the accomplishment of the foregoing and related ends, certain illustrative aspects of the disclosed innovation are described herein in connection with the following description and the annexed drawings. These aspects are indicative, however of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the electronic lock of the present invention in accordance with the disclosed architecture;

FIG. 2A illustrates a perspective view of the upper lock body member of the embodiment of the present invention shown in FIG. 1 in accordance with the disclosed architecture;

FIG. 2B illustrates a perspective view of the user and smart phone communicating with the embodiment of the present invention shown in FIG. 2A in accordance with the disclosed architecture;

FIG. 3A illustrates a perspective view of the lower lock body member separate from the detachable battery of the embodiment of the present invention shown in FIG. 1 in accordance with the disclosed architecture;

FIG. 3B illustrates a perspective view of another potential embodiment of the detachable battery unit shown in FIG. 3A separate from the battery charger of the present invention in accordance with the disclosed architecture;

FIG. 3C illustrates a perspective view of the detachable battery unit and the battery charger shown in FIG. 3B of the present invention assembled together for charging the battery in accordance with the disclosed architecture;

FIG. 4A illustrates a perspective view of the upper lock body member separate from the lower lock body member in the unlocked condition of the embodiment of the present invention shown in FIG. 1 in accordance with the disclosed architecture;

FIG. 4B illustrates a perspective view of the upper lock body member and the lower lock body member joined together in the locked condition of the embodiment of the present invention shown in FIG. 1 in accordance with the disclosed architecture;

FIG. 5A illustrates a perspective view of an application of an improved electronic lock of the present invention as previously described in FIG. 1 now installed onto a trailer as a cargo door seal in accordance with the disclosed architecture;

FIG. 5B illustrates an enlarged partial view of the improved electronic lock of the present invention and the cargo doors section as previously described in FIG. 5A in accordance with the disclosed architecture; and

FIG. 6 provides a block diagram showing an exemplary method of using the present invention in accordance with the disclosed architecture.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for an improved electronic lock that can be easily installed on various containers, construction site equipment, vehicles, houses, sheds and other structures. There is also a long felt need in the art for an improved electronic lock that can be easily used for securing cargo and equipment without requiring a key or combination to be entered into the locking mechanism. Instead, the invention can be locked and unlocked using a portable wireless device such as a smart phone. Additionally, there is also a long felt need in the art for an improved electronic lock that can be used to seal trailer or container cargo doors or closures that is reusable. Further, there is a long felt need in the art for an improved electronic lock that has GPS technology built into the device so that the secured cargo can be tracked and monitored. There is also a long felt need in the art for an improved electronic lock that includes a built-in light for luminating the lock and surroundings when it is used in a low-light or nighttime environment. Finally, there is a long felt need in the art for an improved electronic lock that is relatively inexpensive to manufacture, strong and durable, and has a rechargeable battery that in some embodiments can be detached from the lock body or housing for charging while still keeping the cargo secured. In additional embodiments, the battery may be recharged which it remains in the housing, such as electronically coupling with a charging unit. The invention may also have an internal clock unit, RFID tag connect to a sensor for providing additional data on use and status of the lock and may compile environmental information as well as an alarm.

The present invention, in one exemplary embodiment, is an improved electronic lock that is designed to be installed onto a cargo container, storage trailer, tractor-trailer, house, shed, or other structure or vehicle for the purpose of securing or sealing the doors or other closure on the cargo container or trailer. The improved electronic lock includes a housing having an upper lock body member, a lower lock body portion, a lockable shackle, a plurality of lockable shanks, a display, a light for illumination, wireless communication, GPS tracking and a rechargeable battery unit. The improved electronic lock communicates with a mobile wireless communication device, such as a smart phone, and is locked and unlocked using a novel software application that is installed on the smart phone.

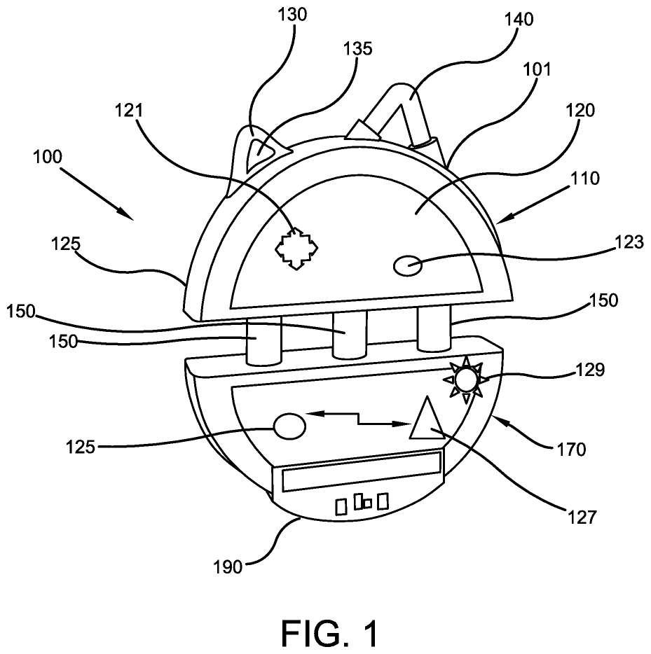

Referring initially to the drawings, FIG. 1 illustrates a perspective view of the preferred embodiment of the improved electronic lock 100 of the present invention as per the disclosed design. The improved electronic lock 100 includes a housing 101, an upper lock body member 110, a lower lock body member 170 and a plurality of lockable shanks 150 that join the upper lock body member 110 and the lower lock body member 170 together when the plurality of lockable shanks 150 are in a locked condition.

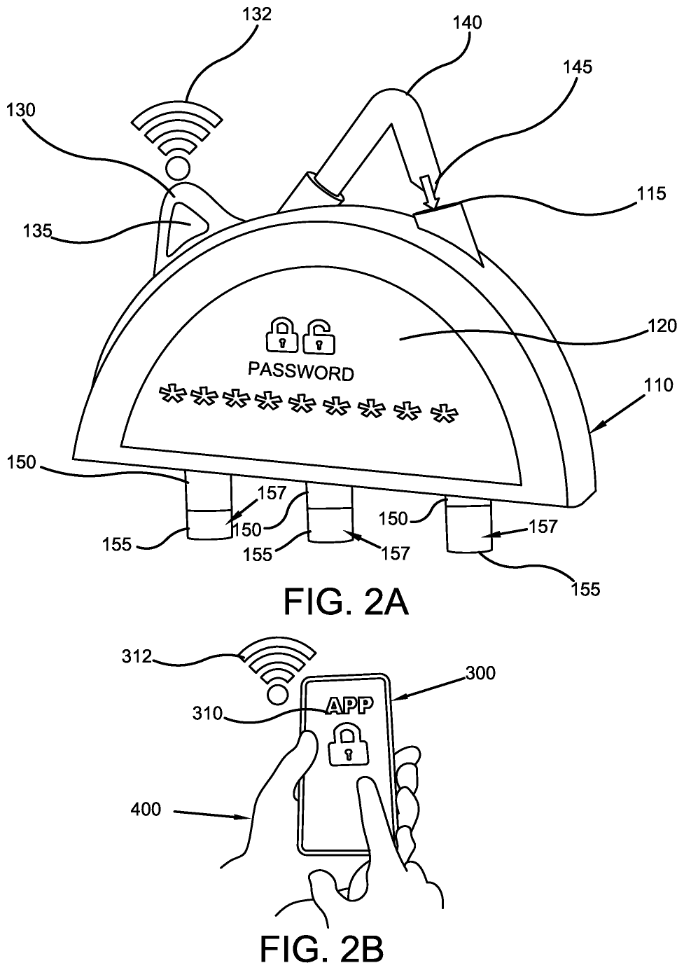

The upper lock body member 110 includes a lockable shackle 140 that is preferably located near the top of the upper lock body member 110. The lockable shackle 140 (shown in a locked condition) and the plurality of lockable shanks 150, typically made from hardened steel, have latching ends 145 and 155, respectively (see FIG. 2A), that can be selectively held in a closed position by internal locking components, such as a locking pawl. The internal locking components are not shown, but are commonly used in traditional mechanical lock mechanisms. In the present invention electronic lock device, the internal locking mechanism is electronically actuated and controlled by an internal control module 125. The internal control module 125 and the internal locking mechanism are powered by a rechargeable battery unit 190. The electronic display 120 and LED light 135 are also connected to the internal control module 125. The display 120 can be used to show the at least one of a serial number, code, time, status of the lock, battery status, tampering indicator or other conditions as may be captured by the RFID tags 126. The housing 101 may also include an internal clock 121, which can be used to provide an additional security feature, only allowing unlocking of the lock after a predetermined amount of time has elapsed. An alarm 123 can be used to emit a continuous tone or regular incremental beeps when the lock is in the locked position. One or more RFID tags 126 may be provided and can be used to collect data on when the lock is unlocked or the tag can have a connected sensor 127 to detect environmental conditions such as temperature, humidity, gases or other conditions which may be important if the contents of the trailer or container are perishable. A GPS unit 129 is also embedded in the housing.

FIG. 2A illustrates a perspective view of the housing 101 having an upper lock body member 110 of the embodiment of the present invention shown in FIG. 1 as per the disclosed design. Now, in FIG. 2B the lockable shackle 140 is shown in an unlocked condition. In this position, the space created between latching end 145 and opening 115 is sufficiently wide enough for attaching it to a latch or hasp having an opening therein. The internal control module 125 communicates with a separate portable wireless device, such as a smart phone 300 (see FIG. 2B) via wireless communication. The upper lock body member 110 includes an antenna 130 for communication with the portable wireless device or smart phone 300. The antenna may also be used by the RFID device as well as the GPS unit to enable communication with the smartphone and to receive signals. The upper lock body member 110 also includes a digital display screen 120 for communicating to the user 400 various status functions of the novel lock device 100, in addition to a high intensity LED light 135 for illuminating the said novel lock device 100 and its surroundings.

The internal control module 125 is connected to all of the electronic subsystems of the improved electronic lock 100 including the display 120, the LED light 135, the rechargeable battery 190, the wireless communication antenna 130, the locking pawls for the lockable shackle 140 and the lockable shanks 150, and the GPS tracking identifier. The internal control module 125 is programmed to have a unique serial number or code for each novel lock device 100 so that it can be paired with the smart phone 300, and may further include a user passcode on the smart phone software application 310 (see FIG. 2B) for accessing the novel lock status and functions.

FIG. 2B illustrates a perspective view of the user 400 and smart phone 300 communicating with the embodiment of the present invention shown in FIG. 2A as per the disclosed specification. The user 400 communicates with the novel lock device 100 using a wireless communication protocol such as Bluetooth® using a smart phone 300. The wireless communication data 312 from the smart phone 300 is sent to/from the wireless communication data 132 on the improved lock device 100 of the present invention through its wireless communication antenna 130.

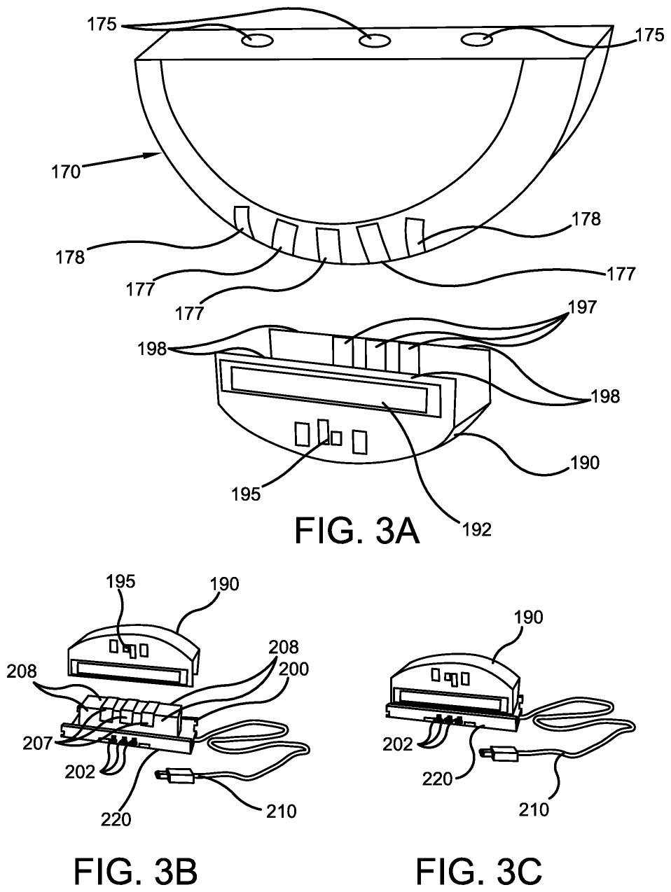

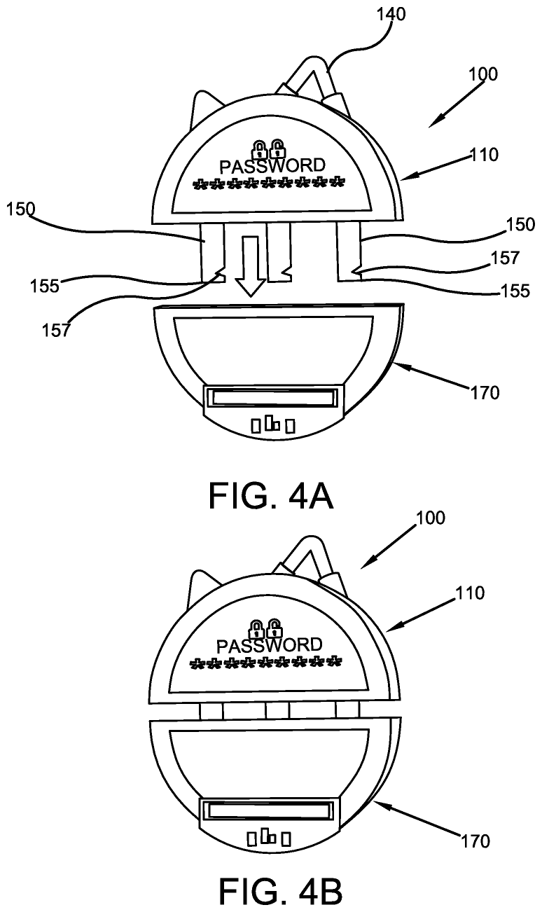

FIG. 3A illustrates a perspective view of the lower lock body member 170 separate from the battery 190 of the embodiment of the present invention shown in FIG. 1 as per the disclosed design. The lower lock body member 170 includes openings 175 for a plurality of lockable shanks 150 that are preferably located on the planar surface near the top of the lower lock body member 170. The size and position of the openings 175 correspond to similar size and position of the latching ends 155 (see FIG. 2A and FIG. 4A) of the lockable shanks 150, which are part of the upper lock body member 110. The lower lock body member 170 further includes electrical contacts 177 and battery attachment notches 178 for receiving a detachable battery unit 190.

FIG. 3B illustrates a perspective view of another embodiment of the detachable battery unit 190 shown in FIG. 3A, separate from the battery charger 200 of the present invention as per the disclosed design. Electrical contacts 197 and battery attachment clips 198 on the detachable battery unit 190 are sized and positioned to mate with the corresponding electrical contacts 177 and battery attachment notches 178 on the lower lock body member 170 as described in FIG. 3A. The same electrical contacts 197 and battery attachment clips 198 on the detachable battery 190 are also used to mate with corresponding electrical contacts 207 and battery attachment notches 208 that are on the charger base 220 of the battery charger 200.

FIG. 3C illustrates a perspective view of the detachable battery unit 190 and the battery charger 220 shown in FIG. 3B of the present invention assembled together for charging the battery 190 as per the disclosed design. A battery release button 195 on the detachable battery unit 190 facilitates removal of the battery unit 190 from either the lower lock body member 170 or the battery charger 200. The power cable 210 on the battery charger 200 is connected to standard household service voltage, and the charging status of the battery unit 190 can be observed via the charging status lights 202 on the charger base 220.

FIG. 4A illustrates a perspective view of the upper lock body member 110 separate from the lower lock body member 170 in the unlocked condition of the embodiment of the present invention 100 shown in FIG. 1 as per the disclosed design. The upper lock body member 110 and the lower lock body member 170 are preferably made from steel or stainless steel, and may include alloys containing Teflon® or other low-friction or self-lubricating materials. The lockable shackle 140 (shown in a locked position) and the lockable shanks 150 are typically made from hardened steel. The internal components of the novel lock 100 such as the locking pawls, actuators, springs, cams, screws and pins are made from similar materials and methods and commonly found on traditional padlocks. The lockable shanks 150 include a locking pawl notch 157 located near the latching end 155 of each of said shanks 150 for contact with a corresponding sized locking pawl/actuator located internal to the lower lock body member 170. When the locking pawl or actuators are retracted, the lockable shanks 150 are slidable, thereby allowing the upper lock body member 110 and the lower lock body member 170 to be separated (i.e., unlocked condition).

FIG. 4B illustrates a perspective view of the upper lock body member 110 and the lower lock body member 170 joined together in the locked condition of the embodiment of the present invention 100 shown in FIG. 1 as per the disclosed design. When the lockable shanks 150 are inserted into the openings 175 (see FIG. 3A) in the lower lock body member 170 and the pawl or actuators are released, the lockable shanks 150 are fixed in place (i.e., locked condition). In a similar manner, the lockable shackle 140 can be selectively unlocked or locked by controlling its locking pawl or actuator with its latching end 145 and corresponding opening 115 in the upper lock body member 110 as best shown in FIG. 2A.

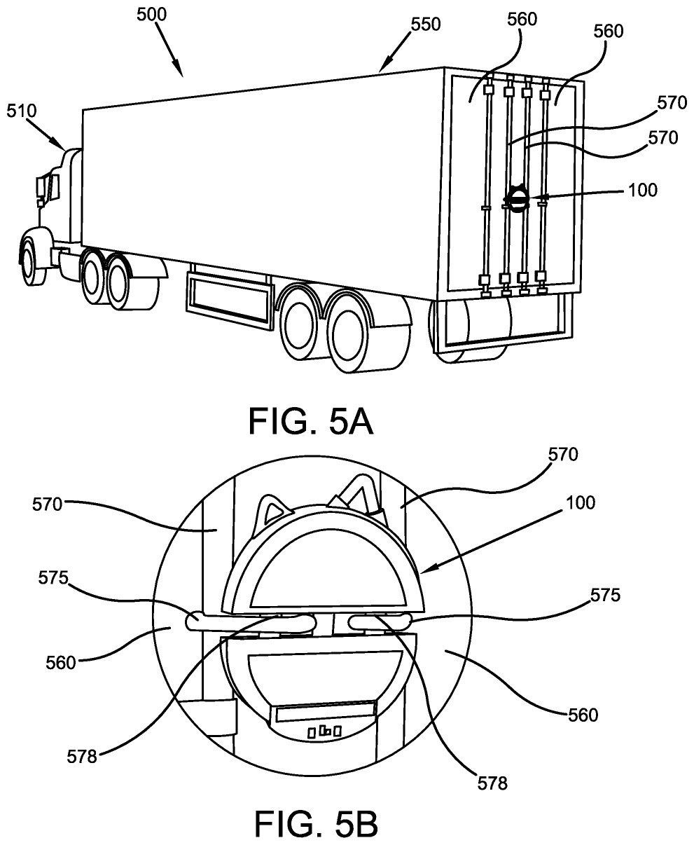

FIG. 5A illustrates a perspective view of an application of an improved electronic lock of the present invention 100 as previously described in FIG. 1 now installed onto a trailer 550 as a cargo door seal as per the disclosed design. A tractor-trailer and improved lock 500 can be described as having a tractor 510 for transporting a trailer or other cargo container 550 whereby it is desirable to place a seal onto the door latch bars 570, thereby preventing any opening or showing tampering of the cargo doors 560. As previously described herein, the present invention lock device 100 can serve as a reusable seal for tractor-trailers and other cargo containers 550 having cargo doors 560 that utilize door latch bars 570 that pivotally rotate allowing the doors 560 to either open or to be secured shut. This particular design of cargo doors 560 can be sealed by either the traditional use once plastic or wire tie or the improved electronic lock device 100. Besides being re-useable, the improved electronic lock device 100 provides additional benefits over the traditional plastic tie, including strong and durable locking, GPS tracking and the ability to be locked/unlocked using the software application 310.

FIG. 5B illustrates an enlarged partial view of the improved electronic lock of the present invention 100 and the cargo doors section as previously described in FIG. 5A as per the disclosed design. Each of the cargo latch bars 570 include a door latch tab 575 having an opening 578. When the cargo doors 560 are shut, a plastic tie can be placed through each of the door latch tab openings 578, thereby preventing rotation of the door latch bars 570. The novel lock 100 can replace the plastic or wire tie by inserting the latching end 155 of the outer two lockable shanks 150 through the opening 578 in each of the door latch tabs 575, then inserting the lower lock body member 170 onto the plurality of lockable shanks 150 and activating the locking process on the smart phone software application 310. The tractor-trailer and improved lock 500 are now ready for transit to its destination. The electronic lock and plastic or wire tie can also be used in combination with one another.

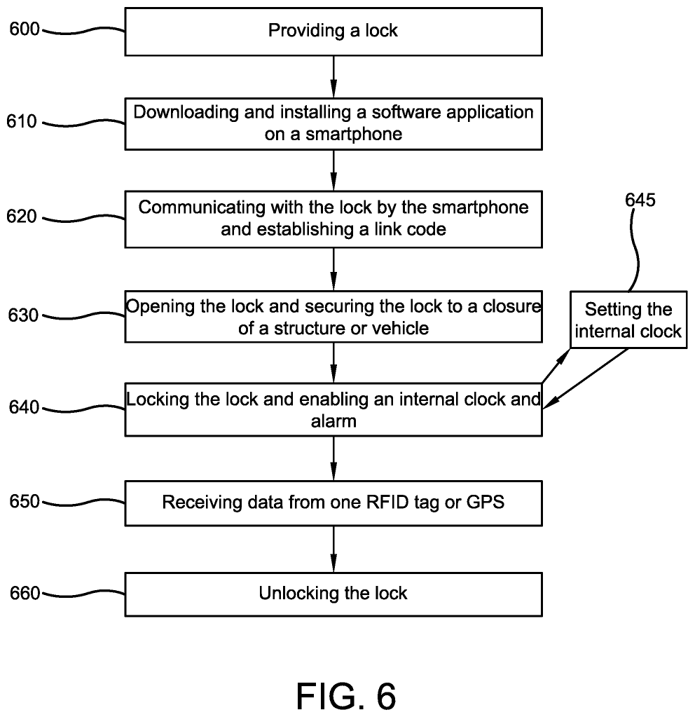

FIG. 6 provides an exemplary block diagram for a method of using the present invention. The method includes the steps of initially providing an electronic lock at step 610 and then at step 620 downloading and installing a software application on a smart device such as a smartphone. At step 630 the smartphone and electronic lock are in communication with one another and establish a locking code. At step 640, the lock is opened and installed on a closure such as a door for a cargo container, trailer, other structure or vehicle and the alarm and clock are activated. Step 645 includes setting the internal clock. At step 650, data is received from one of the GPS or RFID tag and at step 660 the electronic lock is unlocked.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “improved lock”, “improved lock device”, “novel lock device”, and “improved electronic lock” are interchangeable and refer to the improved electronic lock 100 of the present invention.

Notwithstanding the forgoing, the improved electronic lock 100 of the present invention can be of any suitable size and configuration as is known in the art without affecting the overall concept of the invention, provided that it accomplishes the above-stated objectives. One of ordinary skill in the art will appreciate that the size, configuration and material of each of the improved electronic lock 100 as shown in the FIGS. are for illustrative purposes only, and that many other sizes and designs of the improved electronic lock 100 are well within the scope of the present disclosure. Although the dimensions of each of the improved electronic locks 100 are important design parameters for user convenience, the improved electronic lock 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An electronic lock comprising:
a housing having an upper and a lower member, wherein the upper member further comprises a lockable shackle with a plurality of lockable shanks;
a display disposed on the upper member;
a rechargeable battery; and
a control module connected to the display for showing a code or a serial number.

2. The electronic lock as recited in claim 1, wherein the display further displays at least one of a time, a status of the lock, a tampering indicator, a battery status or another condition.

3. The electronic lock as recited in claim 1, wherein the control module is in communication with a GPS module.

4. The electronic lock as recited in claim 1, wherein the housing further comprises at least one of a RFID tag, an alarm, a sensor and an internal clock.

5. The electronic lock as recited in claim 4, wherein the internal clock can be set for a duration of a transit time.

6. The electronic lock as recited in claim 5, wherein the internal clock can prevent opening of the electronic lock prior to expiration of the transit time.

7. The electronic lock as recited in claim 4, wherein the sensor detects at least one of a temperature, a humidity, a gas or another potential contaminant.

8. The electronic lock as recited in claim 1, wherein the a smartphone is in wireless communication with the electronic lock.

9. The electronic lock as recited in claim 4, wherein the alarm emits one of a continuous tone or regular incremental beeps when the electronic lock is in a locked condition.

10. The electronic lock as recited in claim 4, wherein the alarm emits a loud sound when the electronic lock is tampered with or opened prior to an elapsed time.

11. An electronic lock and closure for a container having doors or a closure with a locking mechanism, the electronic lock and closure comprising:
an electronic lock comprised of a housing having an upper member and a lower member, wherein the upper member is comprised of a lockable shackle with a plurality of lockable shanks that engage with the locking mechanism;
a display provided on the housing, wherein the display illustrates at least one of a serial number, a passcode, a time, a status of the lock, a tampering indicator, a battery status or another condition; and
an internal control module connected to the display and a GPS.

12. The electronic lock and closure as recited in claim 11 further comprising a sensor in communication with a RFID device.

13. The electronic lock and closure as recited in claim 12, wherein the sensor provides information on at least one of a temperature, a humidity, and a presence of a gas or other contaminant.

14. The electronic lock and closure as recited in claim 11, wherein a smartphone is in wireless communication with the electronic lock and closure.

15. The electronic lock and closure as recited in claim 11 further comprising a frangible plastic or wire tag to indicate tampering with the electronic lock and closure.

16. The electronic lock and closure as recited in claim 11 further comprising an internal clock that can be set for a duration of a transit time.

17. The electronic lock and closure as recited in claim 11 further comprising an alarm for indicating a tampering with the electronic lock and closure.

18. A method for using an electronic lock device comprising the steps of;
providing an electronic lock;
downloading and installing a software on a smartphone;
communicating wirelessly with the electronic lock via the smartphone;
establishing a lock code for the electronic lock;
opening the electronic lock;
securing the electronic lock to a door or a closure of a storage container;
locking the electronic lock; and
receiving data about the electronic lock from one of a GPS or a RFID tag.

19. The method of using an electronic lock device as recited in claim 18 further comprising a step of setting an internal clock with a transit time.

20. The method of using an electronic lock device as recited in claim 18, wherein RFID tag is connected to a sensor for providing an information on at least one of a temperature, a humidity, and a presence of a gas or other contaminant.
